(19) United States
(12) Patent Application Publication
(10) Pub. No.: US 2016/0328756 A1
(43) Pub. Date: Nov. 10, 2016

(54) SYSTEMS AND METHODS FOR AVAILABILITY BASED COMPUTER MARKETING CAMPAIGN OPTIMIZATION

(71) Applicant: Adobe Systems Incorporated, San Jose, CA (US)

(72) Inventors: Jason A. Carter, Lehi, UT (US); Richard P. Mecham, Lehi, UT (US); Daniel A. McCallum, Payson, UT (US); Cameron R. Cowan, Provo, UT (US)

(21) Appl. No.: 15/216,553

(22) Filed: Jul. 21, 2016

Related U.S. Application Data
(63) Continuation of application No. 13/485,480, filed on May 31, 2012, now abandoned.

(51) Int. Cl. G06Q 30/02; G06Q 10/08

(52) U.S. Cl. CPC G06Q 30/0277; G06Q 10/087

(57) ABSTRACT

Embodiments involve managing online content provided via data networks. For example, the computing system causes a web server to include, during a first time period and in a search results list generated by a search engine, an online advertisement having a webpage link for purchasing a product or service. The computing system determines, subsequent to the first time period, that the product or service's availability has been reduced and that an alternative product or service has a greater availability. The computing system identifies a modification for the online advertisement based on the reduced availability. The modification involves replacing the webpage link with an alternative webpage link for purchasing the alternative product or service. The computing system causes the web server to implement the modification by including, during a second time period and in a second search results list from the search engine, the online advertisement with the alternative webpage link.

### CROSS-REFERENCE TO RELATED APPLICATION

This application is a continuation application of and claims priority to application Ser. No. 13/485,480, title “SYSTEMS AND METHODS FOR AVAILABILITY BASED COMPUTER MARKETING CAMPAIGN OPTIMIZATION” filed May 31, 2012, which is incorporated herein by reference in its entirety.

### BACKGROUND

Internet usage has grown significantly in recent years. To increase revenue and/or visibility, businesses publish websites advertising and/or selling their products and/or advertising their service. Internet search engines (e.g., Google™ Bing™ Yahoo!™) offer users the capability to search for websites by topic, product, service or business using keywords.

To ensure the visibility of the website, business owners create a search engine marketing (SEM) campaign to bid on keywords entered by internet users. The bid amount, along with other factors such as historical click-through rates, ad relevance, and landing page experience, may effect how highly a business's advertisement will be placed in search results for a query including the keyword. A landing page is, for example, a web page linked to an advertisement by a URL embedded in the advertisement such that the user's browser will be directed to the landing page when the user clicks on the advertisement. Businesses may desire to have their keyword-based advertisements appear highly in the search results, thus giving their business high visibility to consumers worldwide. For example, search engine Google™ cites one billion searches per day occur on their search engine. Thus, businesses whose advertisements appear frequently on results pages in response to consumer keyword searches on Google™ will achieve high visibility for their business.

Another approach business owners use to increase revenue and/or visibility is advertising placement on particular websites through advertisement servers. The advertising may be placed on a popular website and/or placed based on the identification of keywords in the content of a given website. Advertisers bid on the keywords to ensure priority of advertisement placement over a competitor's ad.

To assist business owners in the management of their campaign, tools are available for analyzing the results of their campaigns (e.g., SEM and/or advertisement server campaigns) in the context of campaign dollars spent. For example, a clickthrough rate (CTR) reflecting the ratio of the number of times an advertisement appears due to a keyword search to the number of clicks on the same advertisement. The tool may further show the overall cost for the keywords associated with the CTR. However, while the information is useful for monitoring a network-based marketing budget, there is no direct correlation between current availability of a product and/or service and the campaign. Thus, marketing dollars will continue to be spent even if a product is out of stock or a service is not longer available.

### SUMMARY

In some embodiments, a computing system manages an online advertisement campaign by managing, based on availabilities of products or service, content of online advertisements provided via data networks and associated with the products or services. In one example, the computing system transmits, to a web server, a first message via a data network. The first message includes instructions for the web server to include, during a first time period and in a list of search results generated by a search engine, an online advertisement having a webpage link for purchasing a product or service. The computing system determines, subsequent to the first time period, that an availability of the product or service has been reduced and that an alternative product or service has a greater availability as compared to the product or service. The computing system also identifies or otherwise determines a modification for the online advertisement based on the reduced availability of the product or service. The modification involves removing the webpage link from the online advertisement and replacing the webpage link with an alternative webpage link for purchasing the alternative product or service. The computing system transmits a second message to the web server. The second message includes instructions for the web server to implement the modification by including, during a second time period and in a second list of search results generated by the search engine, the online advertisement with the alternative webpage link rather than with the webpage link.

### BRIEF DESCRIPTION OF THE DRAWINGS

FIG. 1A illustrates a configuration that supports availability based computer marketing campaign optimization for a search engine marketing (SEM) campaign, according to one embodiment.

FIG. 1B illustrates a configuration that supports availability based computer marketing campaign optimization for an advertising server, according to one embodiment.

FIG. 2 illustrates a configuration of an advertiser implementing availability based computer marketing campaign optimization, according to one embodiment.

FIG. 3 is a flowchart of a method for availability based computer marketing campaign optimization, according to one embodiment.

FIG. 4 illustrates an example of an availability based search engine (SEM) marketing campaign, according to one embodiment.

FIG. 5 is a flowchart of a decision process in a rules engine, according to one embodiment.

FIG. 6 illustrates an exemplary computer system for use in implementing availability based computer marketing campaign optimization, according to one embodiment.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. Headings used herein are for organizational purposes only and are not meant to be used to limit the scope of the description.

### DETAILED DESCRIPTION

As discussed in more detail below, embodiments provide systems and methods for availability based computer marketing optimization. In some embodiments, one or more product identifiers are mapped at a marketing campaign management tool to one or more elements of a marketing campaign. In some embodiments, the availability status for one or more products corresponding to the one or more product identifiers is received by the marketing campaign management tool. In response to receiving the availability status, one or more of the elements of the availability based computer marketing campaign affected by the availability status are determined by the marketing campaign management tool. In some embodiments, a modification for each affected element based on the availability status is determined by the marketing campaign management tool. In some embodiments, modifications for each affect element of the availability based computer marketing campaign are automatically implemented by the marketing campaign management tool.

For example, a clothing business may use the marketing campaign management tool to manage the cost of a marketing campaign for the business website. Several advertisements for the various clothing products offered by the business may be created. The computer network based marketing campaign may include keywords such as shoes, shirts, pants, etc. In addition, phrases such as blue sweater, striped shirt or corduroy pants may be chosen as keywords, for example. Each of these keywords are mapped to a product identifier at the marketing campaign management tool. Multiple keywords may be mapped to a given product identifier. For example, a product identifier for a blue sweater may have multiple keywords (e.g., blue sweater, sweaters, crew neck sweaters, etc) mapped to the product identifier. In response to an internet user entering one of the keywords in a search engine such as Google™, Yahoo!™ or Bing™, advertising associated with those keywords will appear on the search results page of the search engine. Businesses bid on keywords to ensure that their business advertisement corresponding to the keyword appears in the search results in the top positions of the search engine results page. For example, the top two bids may have their website or advertisement appear above the search engine results while bids three through eight appear in the sidebar next to the search engine results. A business with a large product line may have millions of keywords chosen based on broad or descriptive terms associated with the product line, thus cost of the campaign as a whole can become expensive. The cost may be managed by implementing rules at the marketing campaign management tool that manage the campaign based on changes in availability status for a given product identifier. For example, a rule may be implemented to pause the keyword bidding for a product when the product is out of stock. Another example of a rule that may be implemented is changing the uniform resource locator (URL) for an advertisement in the availability based computer marketing campaign to a URL that points to a product web page for another product that is similar to the advertised product that is out of stock. For example, a business may have a keyword-based marketing campaign for a given item in inventory such as a blue shirt. The blue shirt may run out of stock. To save keyword bid costs, a rule may be implemented to pause the bids for the keywords mapped to the product identifier for the blue shirt until the blue shirts are re-stocked. As another example, while the blue shirts are out of stock, the rule may be configured to maintain the keyword bids and configured to alter the advertisements associated with the blue shirts so that users are directed to red shirts (e.g., by changing the URL corresponding to the advertisement from the blue shirts to the red shirts). By changing the URL for the advertisement, the traffic to the business website is maintained while the item is restocked.

As another example, a business may market their services online. As described above, an availability based computer marketing campaign may be implemented to manage the cost of keyword bids based on availability of a product or service. The keyword bids can provide better placement of the advertisement corresponding to the keyword on search engine results pages. In addition, the business may also utilize an advertisement server as part of their availability based computer marketing campaign. An advertisement server stores advertisements for one or more businesses and in response to keywords appearing on a webpage, the advertisement is displayed to a user of the webpage. The marketing campaign management tool may implement a rule to lower keyword bidding for a specific service if the business services are fully booked or contracted. Alternatively, if the business wishes to advertise a promotional event, the business may implement a rule in the marketing campaign management tool to increase keyword bidding for the keywords corresponding to the advertisement until the time-slots have been filled. The marketing campaign management tool may communicate with the advertisement server to implement the changes.

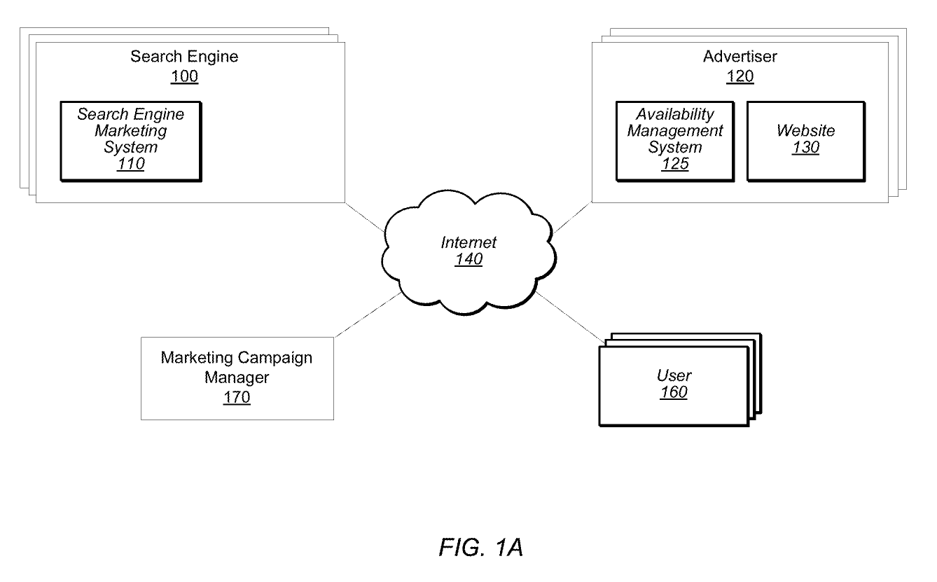

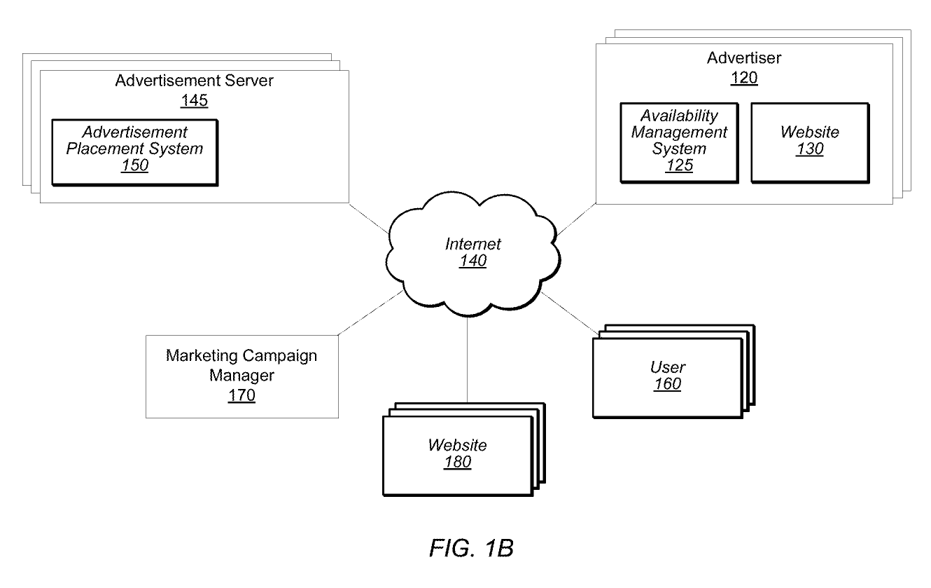

FIG. 1A illustrates a configuration that supports availability based computer marketing optimization for a search engine marketing (SEM) campaign, according to one embodiment. In general, search engines 100 allow internet users 160 to search for information based on keywords. Keywords may be a single word (e.g., dog) or a phrase (e.g., dog supplies). Search engines will display the results of the keyword search as a list of relevant websites, for example. In addition, advertisers 120 can pay, via keyword bidding, to display advertising for their business in the search results displayed to user 160. This method of advertising may employ keyword bidding management through a marketing campaign management tool such as marketing campaign manager 170. Advertisers with the highest bid on a keyword will ensure that their advertisement is displayed first or most often on search engine 100 and advertisement server 145. Advertisers 120 map their current inventory to the keyword bid management for the search engine marketing system 110 via marketing campaign manager 170 to manage costs. The availability management system 125 may track the availability status of the advertiser 120 products or service. Marketing campaign manager 170 receives the availability status and applies rules to determine a keyword bidding strategy or advertisement strategy based on the current availability status. For example, if an item is out of stock or if a service is fully booked, the keyword bidding strategy or rule for the given item or service may be to reduce the bids for one or more keywords. This will be described in further detail below.

In some embodiments, advertisers 120 sell a product (e.g., clothing, books, etc.), sell a service (e.g., pest control, maid service, etc.) or promote an event (e.g., concerts, charity events, etc.). Advertisers 120 create a website 130 to reach a wider audience. Website 130 includes information the advertisers wish to convey to a user 160 viewing the website. For example, advertisers 120 selling a product may have a website with multiple links to view individual product web pages. Each individual product page may link to a purchase point web page. As another example, advertisers 120 selling a service may offer details of the services offered, price lists and contact information to schedule a service visit. Users 160 can access advertisers 120 website 130 via internet 140 by directly entering the uniform resource locator (URL) of the business website (e.g., www.anybusiness.com) or by performing a keyword search in search engine 100. For example, users 160 interested in locating businesses that sell a given service such as pest control can enter the keyword “pest control Austin Tex.” in search engine 100 and receive a list of pest control businesses in the Austin, Tex. area. Selecting one of the URLs in the list will redirect the user to the corresponding business website.

Advertisers 120, in some embodiments, maintain an availability management system 125. Availability management system 125 stores the current availability of the product, service or event, in some embodiments. Availability management system 125 may be configured to include a database, file, and/or software configured to track status. For example, a retail business may maintain an inventory of the goods sold through the business. As another example, a service business may maintain available time slots through an availability management system 125. As another example, a business promoting an event may maintain an inventory of tickets for each day of the event.

In some embodiments, marketing campaign manager 170 manages the interaction with the search engine marketing system 110 of search engine 100. Marketing campaign manager 170 maps product identifiers associated with a product to one or more elements of an availability based advertising campaign, in some embodiments. For example, marketing campaign manager 170 may map the products of a retail business to keywords and/or advertisements corresponding to a given product. In response to users 160 entering the keyword in search engine 100, the advertisement corresponding to the keyword is displayed on the webpage or search engine results page. To manage the availability based computer marketing campaign, advertisers 120 configure rules corresponding with each product identifier in marketing campaign manager 170, in some embodiments. Marketing campaign manager 170 receives the availability status from availability management system 125. In response to a change in availability status, marketing campaign manager 170 determines the rule for the product identifier and implements the rule in search engine marketing system 110. For example, advertiser 120 may be a concert promoter. Advertiser 120 may configure rules for each event to ensure that keyword bidding and advertisements for concerts that are sold out or past their event date does not continue. If a concert event sells out, a rule pausing the keyword bidding corresponding advertisement advertising the sold out event date may be implemented at search engine marketing system 110. As another example, a retail business may configure a rule at marketing campaign manager 170 for a product identifier corresponding to a blue striped shirt that redirects users 160 to a red striped shirt if the inventory of the blue striped shirt falls below a certain threshold. The rule may maintain the keyword bid so that visibility to user 160 is not lost, but until the blue striped shirt is restocked, users 160 will see an alternate selection. This will be described in more detail below.

Search engine 100 is a network-based portal for users 160 to search for products, services, and/or information, in some embodiments. Examples of search engine 100 are Google™, Bing™, and/or Yahoo!™ Users 160 initiate their search for goods, services, and/or information via keywords. Keywords may range from one word to multiple words. For example, a user 160 searching for a television, may enter the keyword “television” in search engine 100. User 160 may narrow the search in search engine 100 to “19” televisions” or “19” televisions wall mount”. In response to user 160 entering the keyword, the keyword based results are presented to user 160, in some embodiments. User 160 can select a link from a list of results presented in keyword based results display 105 or select a link in a text based advertisement presented in the top or right side of the keyword based results in some embodiments. Selecting the link will display a new webpage.

Search engine 100 implements search engine marketing system 110, in some embodiments. Search engine marketing system 110 is a mechanism to bid on keywords to ensure placement of their advertisements in relevant search results in the keyword based results displayed to users 160. In search engine marking system 110, advertiser 120 creates one or more campaigns corresponding to the products or services advertisers 120 are selling via marketing campaign manager 170. Within a campaign, there may be one or more advertisement groups including one or more advertisements and/or one or more keywords. The one or more advertisements are text based advertisements depicting one or more products and/or services for sale and a link to a website dedicated to the product and/or service for sale. Each advertisement group within the campaign may have one or more keywords corresponding to the one or more advertisements in the advertisement group. When a user enters the keyword, the corresponding advertisement appears in the search results. To continue the example above, the advertiser 120 of the blue striped shirt may select, but is not limited to, the following keywords: shirt, blue shirt, blue striped shirt, striped shirt, short sleeved shirts, men's shirts, v-neck shirts, cotton shirts, and/or any other descriptive information associated with the blue striped shirt. Advertiser 120 bids on each of the keywords via marketing campaign manager 170 so that the advertisement corresponding to the keyword appears in search engine 100 s keyword based results. To manage the cost of the keyword bids based on the availability of products and/or services, advertisers 120 map product identifiers (e.g., an identifier for a blue shirt) to one or more keywords. As discussed above, marketing campaign manager 170 maintains rules configured by advertiser 120 that are implemented when the availability of a given product falls below a given limit. For example, advertiser 120 may configure a rule to pause keyword bidding for a keyword if the inventory corresponding to a product identifier mapped to the keyword falls below a given limit.

While the examples of search engines presented herein are discussed with respect to current implementations search engines and advertisement servers, one of skill in the art will readily ascertain in light of having read the present disclosure that the invention is not so limited, and that search engines with other embodiments of keyword bidding and managements systems fall within the scope and intent of the present disclosure.

FIG. 1B illustrates a configuration that supports availability based computer marketing campaign optimization for an advertising server, according to one embodiment. Advertising servers 145 store one or more advertisements and display them on relevant websites, e.g., via keyword matching. For example, if a user (e.g., user 160) is viewing a website 180 with content related to sports, advertising related to a sporting goods store may appear in advertisements placed in the margins surrounding the content of website 180. Selecting the advertisement will display the advertiser's website 130 to user 160. Advertisers 120 bid on keywords or otherwise specify advertisement campaigns corresponding to their product and/or service to ensure placement of their advertisements on website 180 via advertising server 145. As discussed above in FIG. 1A, to manage costs and the campaign, a marketing campaign management tool such as marketing campaign manager 170 stores mappings and rules and implements rules based on the availability of advertisers 120 product and/or service. The mappings map a product identifier corresponding to a product and/or service to keywords corresponding to advertisements. A rule that may be configured by advertiser 120 in marketing campaign manager 170 may be based on the availability of a promotion by advertiser 120. For example, advertiser 120 may have seasonal sales for a given product and configure rules to pause the keyword bidding based on the availability of the products on sale. Marketing campaign manager 170 stores and implements the rules based on the availability received from availability management system 125.

In some embodiments, advertisement servers 145 place advertising on website 180 with content that includes one or more particular keywords. Advertisers 120 create one or more advertisements for advertisement server 145. Advertisement server 145 displays advertisements relevant to the content viewed by user 160. For example, if user 160 is viewing a news story on a website 180 describing the latest weight loss studies, advertisement server 145 may display advertisements corresponding to gyms, weight loss food products or doctors specializing in weight loss services. The advertisements displayed are based on keywords corresponding to the advertisement and found in the article. In this example, the keywords may be, but are not limited to, weight, weight loss, exercise, low calorie food, weight lifting, physicals and/or bariatric surgery.

In some embodiments, marketing campaign manager 170 manages the bids for keywords while advertisement placement system 150 determines which advertisement to display based on the keyword bids. As described above in FIG. 1A, advertisers 120 map product identifiers to keywords via marketing campaign manager 170. Advertisers 120 bid on the keywords mapped to the product identifiers via marketing campaign manager 170 in advertisement server 145. For example, advertiser 120 may be a carpet cleaning service. To engage new clients (e.g., users 160), advertiser 120 may create an advertisement depicting a given service such as steam cleaning furniture and offer a sale price. In addition, advertiser 120 may create a rule in marketing campaign manager 170 that is implemented when the number of new clients found through the sale price offer reaches a predetermined value as determined by availability management system 125. The rule may stop bidding on the keywords in advertisement management system 150 associated with the advertisement in advertisement storage 155 when the number of new clients reaches the predetermined value. The rule implemented may also redirect clients (e.g., user 160) to another portion of website 130 where a list of offered services can be found. The rules will be described in more detail below.

As discussed above, advertisers 120 sell a product (e.g., clothing, books, etc.), sell a service (e.g., pest control, maid service, etc.) or promote an event (e.g., concerts, charity events, etc.). Advertisers 120 create a website 130 to reach a wider audience. Website 130 includes information the advertisers wish to convey to a user 160 viewing the website. Users 160 can access advertisers 120 website 130 via internet 140 by directly entering the uniform resource locator (URL) of the business website (e.g., www.anybusiness.com). Users 160 can also locate websites 180 via search engines (e.g., search engine 100 in FIG. 1A).

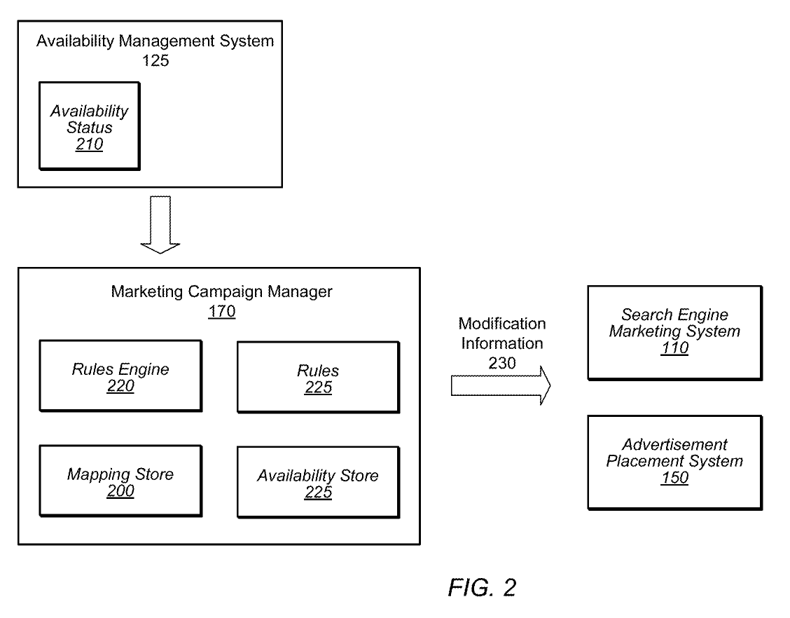

FIG. 2 illustrates a configuration of an advertiser implementing availability based computer marketing optimization, according to one embodiment. In general advertiser 120, implements an availability based computer marketing campaign to manage the costs of the computer marketing campaign. Advertiser 120 tracks the availability status 210 of their product, service and/or event via an availability management system 125. Within marketing campaign manager 170, in some embodiments, a mapping store 200 stores the mapping between a product identifier and keywords and/or advertisements for search engine marketing system 110 and/or advertisement placement system 150. The availability of each product and/or service, by product identifier, offered by advertiser 120 is determined. In response to a change in availability for one or more products and/or services, rules engine 220 accesses mapping store 200, rules 225 and availability status 210 to determine whether to send modification information 230 to search engine marketing system 110 and/or advertisement placement system 150. The rules in rules engine 220 are configured by each advertiser 120. The rules may adjust a keyword bidding strategy based on a given availability status, for example. As another example, the rules may redirect the potential buyer (e.g., user 160 in FIG. 1) to other product information if the initial item is out of stock. The other product information may be depicted in an advertisement for a related product, for example. As another example of a rule, the advertisement copy itself may be modified based on the availability status of a given product or service. The rules stored in rules 225 and implement by rules engine 220 determine the modification information 230 (e.g., change advertisement copy or adjust keyword bid) that is communicated to search engine marketing system 110 and/or advertisement placement system 150. Marketing campaign manager may be a software tool provided by a network-based service, or may be s software tool run locally by advertiser 120, for example.

In some embodiments, mapping store 200 maintains the mapping of product identifiers to one or more keywords and/or advertisements. A product identifier (not explicitly shown) represents actual product, an aspect of a service or an aspect of an event. To continue the examples described above, a given product identifier may represent a blue striped shirt, a specific service such as steam cleaning furniture and/or a tickets for a particular concert date, for example. As discussed above, each product identifier is mapped to one or more key words. For example, if the product identifier corresponds to the blue striped shirt, the keywords mapped to it may be, but is not limited to, “shirt”, “blue shirt”, “blue striped shirt” and/or “striped shirt”. Each of these keywords will affect which advertisement is displayed through the search engine results (e.g., from search engine 100) and/or advertisement server 145. This will be described in further detail below.

In some embodiments mapping store 200 stores information indicating whether the rules 225 as implemented by rules engine 220 are due to a specific event. For example, a clothing retailer may track whether rules for their product identifiers were implemented due to an item depleting stock or replenishing stock. As another example, an event promoter may track whether the rules change was implemented due to a new concert date.

In some embodiments, availability status 210 maintains the availability of the product and/or service offered by an advertiser (e.g., advertiser 120 in FIG. 1A). For example, availability status 210 may be the inventory of each of the products offered by a retailer. As another example, the availability status may be the number of tickets and/or seats available for an event. As another example, the availability status may be the number of time slots available for a given service (e.g., pest control) or the number of promotional packages available for a service. The availability status 210 can be configured in any format. Availability status 210 configurations may be, but are not limited to, files, databases and/or scheduling tools, in some embodiments. In some embodiments, marketing campaign manager 170 is configured to retrieve the availability status (e.g., via API, screen scraping technique, web scraping technique, etc.). In other embodiments, distinct column headings and/or other identifiers are implemented to facilitate parsing the information in availability status 210 by marketing campaign manager 170.

In some embodiments, rules engine 220 is configured by advertiser 120 to implement rules based on the availability status 210, the mappings in mapping store 200, and/or the rules stored in rules 225. The rules implemented determine actions for keyword bidding and/or advertisement information, in some embodiments. The rules may be configured via a user interface in marketing campaign manager 170 or predetermined by advertisers (e.g., advertisers 220 in FIG. 1A) and stored in rules 225. As described above, each product identifier corresponding to a product and/or service availability in availability status 210 is mapped to one or more elements of an availability based computer marketing (e.g., keywords, advertisements) in mapping store 200. For each product identifier, the rules engine determines, based on availability status 210 received from availability management system 125 and the rules stored in rules 225, one or more actions. For example, a rule may be implemented to change keyword bidding based on the availability status of a particular item. If the availability status for the particular item drops below a certain value, the bids for the keywords corresponding to the product identifier for the particular item may be paused until the item is restocked. As another example, a rule may be implemented to redirect users to another webpage based on the availability status. For example, a concert may sell out on a given date and subsequent users may be redirected to a website for another available date or the overall tour schedule. As another example, a rule may be implemented to change the copy of an advertisement on an advertisement server (e.g., advertisement server 145 in FIG. 1) based on the availability status. For example, an advertiser offering cleaning services may change the advertisement copy for its business from an advertisement with a sale price to an advertisement with a regular price once a promotional offer has been exhausted. Rules engine 220, transmits modification information 230 (e.g., the one or more actions determined by rules engine 220) to search engine marketing system 110 and/or advertisement placement system 150, in some embodiments. Detailed examples of rules implementation will be discussed below.

In some embodiments availability store 225, is configured to store the last availability status 210 from availability management system 125. Marketing campaign manager 170 compares the last stored availability status from availability store 225 to determine if there has been a change in availability status. In alternate embodiments, any changes to the availability status may be determined in availability management system 120 prior to communicating the information to marketing campaign manager 170.

In some embodiments, search engine marketing system 110, is a component of a search engine (e.g., search engine 100 in FIG. 1A) configured to receive the availability based marketing campaign of one or more advertisers from marketing campaign manager 170. Search engine marketing system 110 campaigns include, advertisement groups, and/or keywords. These choices impact the results displayed in portions of the search engine results display to a user (e.g. user 160 in FIG. 1A). For example, search engines typically display the advertisements in the upper portion of the results webpage and/or on the right side of the results webpage. The position of the advertisement (e.g., first, second) is based on the keyword bidding process. The results displayed in the middle and/or main portion of the results webpage are results based on each search engine (e.g., search engine 100 in FIG. 1A) search algorithms. The advertisements are text based advertisements determined by the advertiser (e.g., advertiser 120) and include information such as the advertiser website link (e.g., website 130 in FIG. 1A) and a short description of the product. In response to a user (e.g., user 160 in FIG. 1A) entering a keyword in the search engine (e.g., search engine 100 in FIG. 1A), one or more advertisements will be displayed based on the highest bids for the keywords. For example, an advertiser with the highest bid on a given keyword will have their advertisement displayed in the first position on the search engine results page displayed to users (e.g., users 160 in FIG. 1A).

In some embodiments, advertisement placement system 150, is a component of an advertisement server (e.g., advertisement server 140 in FIG. 1). Advertisement placement system 150 receives key word bids from marketing campaign manager 170 and as a result of the keyword bids, determines which advertisement will be placed on a relevant website. A relevant website may be a website that includes the keywords in the content of the relevant website and/or in embedded keywords within the website. For example, advertisements for dog sitting services may only be placed on website with content including keywords relating to dogs.

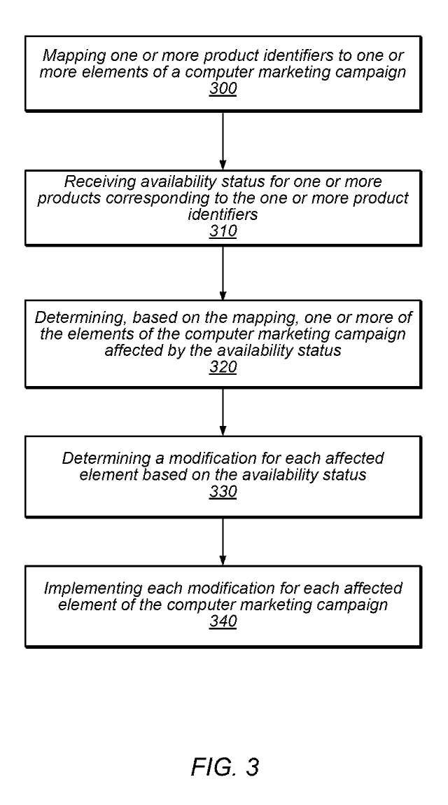

FIG. 3 is a flowchart of a method for availability based marketing campaign management, according to one embodiment. The method may be performed by a marketing campaign management tool as described above. As discussed above, advertisers (e.g., advertisers 120 in FIG. 1) create an availability based marketing campaigns via marketing campaign manager 170. The campaigns can be in the form of advertisement placement in search engine results (e.g., search engine 100) and/or in advertisements from advertisement servers (e.g., advertisement server 145). The availability (e.g., availability status 210 in FIG. 2) of the products and/or services from the advertisers is mapped to keywords. Keywords are the search terms that users (e.g., user 160 in FIG. 1A) enter in a search engine (e.g., search engine 100 in FIG. 1A) to locate information. These keywords correspond to text based advertisements in advertisement groups of an SEM campaign created by the advertiser via marketing campaign manager 170. In response to a user entering a keyword in a search engine search window, advertisements with the highest bid on the corresponding keyword are displayed first. Keywords are also used by advertisement servers to identify placement for advertisements on websites (e.g., websites 180 in FIG. 1B) that include content corresponding to keywords. To manage costs of the campaigns while maintaining visibility of the advertisements in either campaign, advertisers can manage bids on the ads via marketing campaign manager 170.

As indicated in 300, in some embodiments, one or more product identifiers are mapped to one or more elements of an availability based computer marketing campaign. As discussed above product identifiers represent actual product inventory and/or services of an advertiser (e.g., advertiser 120 in FIG. 1). Each product identifier is mapped to one or more keywords and/or advertisements as part of an availability based computer marketing campaign. The keywords typically correspond to some aspect of a product. For example, a retailer selling shoes may choose keywords such a “tennis shoe”, “brown shoe”, “dress shoe”, and/or “shoe” as keywords to map to a product identifier representing a given shoe. When a user (e.g., user 160 in FIG. 1) enters one of the above described keywords in a search engine, the advertisements corresponding to the keywords may appear in the search engine results if the bid was higher than the other bidders for the respective keyword. The advertisements may provide a link to the product page describing the shoes corresponding to the product identifier. In addition, the keywords may be used by an advertisement server (e.g., advertisement server 145) to identify placement of the advertisements on the appropriate website.

As indicated in 310, in some embodiments, the availability status for one or more products corresponding to the one or more product identifiers is received. As discussed above, the availability status (e.g., availability status 210 in FIG. 2) can be in several formats such as a database, file and/or other tool configured to track information. In some embodiments, a marketing campaign manager 170 is configured to retrieve the availability status from an availability management system (e.g., availability management system 125 in FIG. 1B). In alternate embodiments the availability status is retrieve (e.g., by marketing campaign manager 170) via an application programming interface (API) or a pre-determined format. As a non-limiting example, the availability status of each product may indicate that a product is out-of-stock, in-stock, sold out, and/or discontinued. For example, retailers may track the inventory of their products. In addition, in some embodiments, the availability status is received (e.g., by marketing campaign manager 170 in FIG. 2) on a periodic basis. For example, a retailer with high volume sales or an event promoter for a popular event may update the availability status several times a day.

As indicated in 320, in some embodiments, based on said mapping, one or more of the elements of the availability based computer marketing campaign affected by the availability status are determined. In some embodiments, if the availability status (e.g., availability status 210 in FIG. 2) indicates that a given product identifier has a change in status, one or more elements mapped to the product identifier are determined (e.g., by rules engine 220 in FIG. 2). For example, if a product identifier is mapped to one or more advertisements and/or one or more keywords, these elements are identified.

As indicated in 330, in some embodiments, a modification for each affected element based on the availability status is determined. Once each element mapped to the product identifier (e.g. in mapped store 200 in FIG. 2) identified by the change in availability status is determined, the rules for each change in availability status are determined (e.g., by rules engine 220 accessing rules 225 in FIG. 2). For example, if an item is out of stock, the rule may indicate that the modification is to stop bidding on the keywords corresponding to the product identifier. As another example, if a product is discontinued or an event and/or promotion sold out, the rules may indicate that the modification is to redirect the advertisement to another website. For example, if jeans are discontinued, the advertisement may redirect users to athletic pants. As another example, if a promotional event for a service company has expired, the advertisement may be modified to an advertisement depicting the overall service list for the service company.

As indicated in 340, in some embodiments, each modification for each affected element of the availability based computer marketing campaign is implemented. Once the modifications have been determined, the modification information (e.g., modification information 230 in FIG. 2) is communicated to a search engine marketing system of a search engine (e.g. search engine marketing system 110 in search engine 100) in FIG. 1) and/or an advertisement placement system (e.g. advertisement placement system 150 in advertisement server 145 in FIG. 1), in some embodiments. In response to the modification information, keyword bids are changed (e.g., in search engine marketing system 110 in FIG. 2) and/or the advertisements (e.g., in advertisement placement system 150) changed.

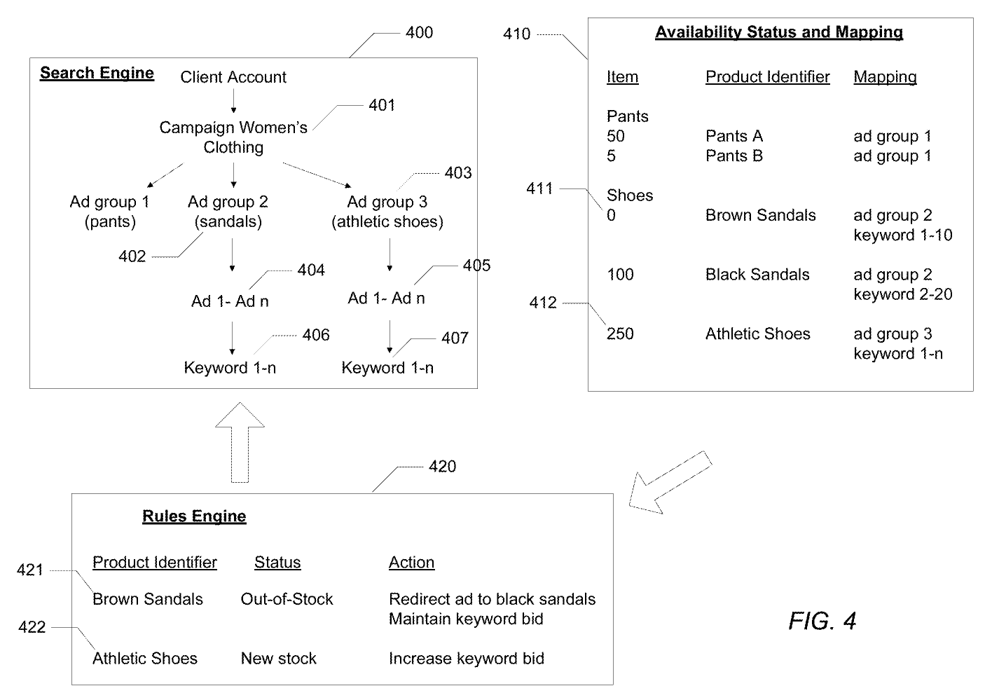

FIG. 4 illustrates an example of an availability based computer marketing campaign, according to one embodiment. As discussed above, advertisers implement availability based computer marketing campaigns to manage the costs of a computer marketing campaign. Availability based computer marketing campaigns are implemented on search engines (e.g., Google™, Bing™) and/or advertisement servers. A search engine marketing (SEM) campaign may implement one or more campaigns including one or more advertisement groups. Each advertisement group may include one or more advertisements and/or one or more keywords. In some embodiments, advertisers bid on keywords to ensure high visibility placement of their advertisements in the search results based on the keywords entered by users (e.g., search engine 100 in FIG. 1A). For example, an advertiser of dog products may have the highest bid on “yellow dog collars”. In response to a user entering “yellow dog collars” in the search engine search window (e.g., search engine 100 in FIG. 1A), a user will see an advertisement for the advertiser of the dog products in the first position of the search engine results (e.g., keyword based results display in FIG. 1).

A search engine marketing campaign client account may be configured (e.g., by marketing campaign manager 170 in FIG. 2) as depicted in search engine client account 400. A given campaign may include one or more advertisement groups. An advertisement group may represent a general product group such as sandals or athletic shoes for a retailer, for example. Each advertisement group includes one or more advertisements and one or more keywords. For example, advertisement group 2 402 depicted in search engine client account 400 has multiple advertisements 404 for sandals corresponding to multiple keywords 406. In some embodiments, each of these advertisements has a text description of the product and a link to select to view the webpage (e.g., webpage 130 in FIG. 1A) for the product. For example, the link may be a direct link to the product (e.g., different types of sandals offered) or a link to the main page of the business (e.g., the retailer selling the sandals). In some embodiments, each advertisement (e.g., advertisement 404) has one or more keywords (e.g., keywords 405) associated with it.

The availability and mapping 410 (e.g., from availability status 210 or availability store 225 and mapping store 200) for one or more product identifiers is received by rules engine 420 may be as depicted in FIG. 4. The availability status for brown sandals 411 is 0 and it is mapped to advertisement group 2 and keywords 1-10. Rules engine 420 determined that when brown sandal 421 is out-of-stock, the action is to redirect the advertisement to black sandals and maintain the current level of keyword bids. Rules engine 420 communicates the modification information to search engine 400 client account to change the text in advertisement 1-n 404 to depict the webpage with the black sandals.

As another example, availability status and mapping 410 is athletic shoes 412. The availability status and mapping indicates that athletic shoes 412 are newly stocked. Rules engine 420 receives the information and determines that the rule 422 (e.g. from rules 225 in FIG. 2) for athletic shoes is to increase the keyword bids. The modification information (e.g. modification information 230 in FIG. 2) is communicated to the search engine and the keywords for advertisement group 3 403 have their bids increased.

Although, this example, depicted a simple view of availability based marketing campaign, a client configuring a search engine marketing campaign may have multiple campaigns with hundreds of advertisement groups, thousands of advertisements and millions of keywords. Thus, rules engine 420 (e.g., rules engine 220 in FIG. 2) may have millions of entries to manage each of the keywords and/or advertisements corresponding to one or more product identifiers.

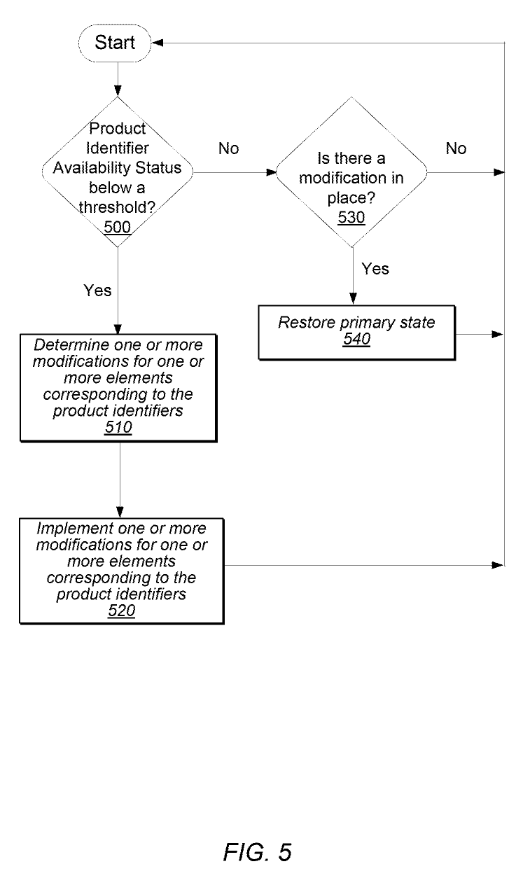

FIG. 5 is a flowchart of a decision process in a rules engine, according to one embodiment. As discussed above, a rules engine (e.g., rules engine 220 in FIG. 2) accesses rules (e.g., rules 225 in FIG. 2) configured by an advertiser (e.g., advertiser 120 in FIG. 1) to implement rules based on the availability status (e.g., availability status 210 in FIG. 2) and the mappings in a mapping store (e.g., mapping store 200 in FIG. 2). The rules implemented determine actions for keyword bidding and/or advertisement information, in some embodiments. As described above, each product identifier corresponding to a product and/or service in the availability status (e.g., availability status 210 in FIG. 2) is mapped to one or more elements of an availability based computer marketing campaign (e.g., keywords, ads) in the mapping store (e.g. mapping store 200).

As indicated in 500, in some embodiments, for a given product identifier it is determined if the availability status is below a threshold. If the status is below a threshold then, as indicated in 510, one or more modifications for one or more elements corresponding to the product identifiers is determined. For example, a rules engine as described in FIG. 2 may determine that the modification is to pause keyword bidding based on the availability status and the rules stored (e.g., in rules 225 in FIG. 2). As another example, if the keyword bidding strategy will not be changed, a secondary URL may be indicated. The secondary URL may direct the user (e.g., user 160 in FIG. 1A) to a similar product, for example.

As indicated in 520, in some embodiments, one or more modifications for one or more elements corresponding to the product identifiers is implemented. For example, a rules engine as described in FIG. 2 may implement the modification in a search engine marketing system as described in FIG. 1A or in an advertisement placement system as described in FIG. 1B.

As indicated in 530, in some embodiments, if the product identifier availability status is not below a threshold, it is determined if there is an availability-based modification already in place. If there is not an availability-based modification in place, then the next product identifier is evaluated as indicated in 500. If there is an availability-based in place, then restore the primary state as indicated in 540, in some embodiments. If the product availability status is no longer below the threshold, then a previous availability-based modification may no longer be necessary. For example, if keyword bidding was paused because product availability had previously dropped below the threshold, if it is determined at 500 that availability is no longer below the threshold, then key word bidding may be resumed at 540. However, if keyword bidding had been paused or stopped for some other reason (e.g., a modification that was not based on a change in product availability), then no action would be taken at 530. In some embodiments, an availability-based modification may be setting a secondary URL for the ad. For example, the primary URL for the ad may point to a specific product or service such as carpet cleaning services. The primary URL for the ad may be a link to a webpage offering promotional prices. Once the promotion has expired, they advertiser may be interested in maintaining the traffic to the business website, but change the URL for the ad to the overall services webpage instead of the promotional page.

### Exemplary Computer System

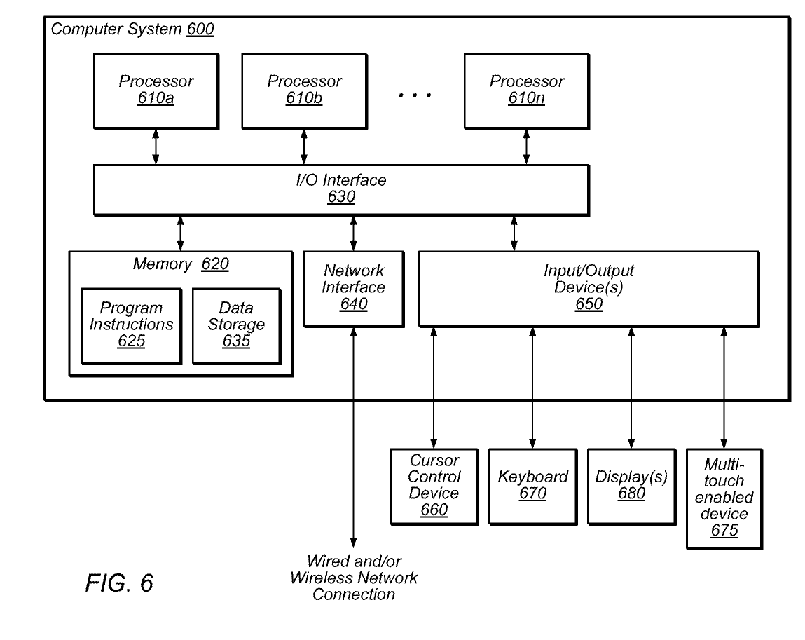

FIG. 6 is a diagram that illustrates an exemplary computer system 600 in accordance with one or more embodiments of the present technique. Various portions of the systems in FIGS. 1-2 and/or methods presented in FIGS. 3-4 and/or described herein, may be executed on one or more computer systems similar to that described herein, which may interact with various other devices of the system.

In the illustrated embodiment, computer system 600 includes one or more processors 610 coupled to a system memory 620 via an input/output (I/O) interface 630. Computer system 600 further includes a network interface 640 coupled to I/O interface 630, and one or more input/output devices 650, such as cursor control device 660, keyboard 670, audio device 690, and display(s) 680. In some embodiments, it is contemplated that embodiments may be implemented using a single instance of computer system 600, while in other embodiments multiple such systems, or multiple nodes making up computer system 600, may be configured to host different portions or instances of embodiments. For example, in one embodiment some elements may be implemented via one or more nodes of computer system 600 that are distinct from those nodes implementing other elements.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments, processors 610 may be general-purpose or embedded processors implementing any of a variety of instruction set architectures (ISAs), such as the x86, PowerPC, SPARC, or MIPS ISAs, or any other suitable ISA. In multiprocessor systems, each of processors 710 may commonly, but not necessarily, implement the same ISA.

In some embodiments, at least one processor 610 may be a graphics processing unit. A graphics processing unit (GPU) may be considered a dedicated graphics-rendering device for a personal computer, workstation, game console or other computer system. GPUs may be very efficient at manipulating and displaying computer graphics and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods disclosed herein for layout-preserved text generation may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 620 may be configured to store program instructions and/or data accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for a layout-preserved text generation method, are shown stored within system memory 620 as program instructions 625 and data storage 635, respectively. In other embodiments, program instructions and/or data may be received, sent or stored upon different types of computer-accessible media or on similar media separate from system memory 620 or computer system 600. Generally speaking, a computer-accessible medium may include storage media or memory media such as magnetic or optical media, e.g., disk or CD/DVD-ROM coupled to computer system 600 via I/O interface 630. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 640. Program instructions may include instructions for implementing the techniques described with respect to methods depicted in FIGS. 3-4.

In some embodiments, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components. In addition, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., data collection server 160), such as other computer systems, or between nodes of computer system 600. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 650 may, in some embodiments, include one or more display terminals, keyboards, keypads, touchpads, scanning devices, voice or optical recognition devices, multi-touch screens, or any other devices suitable for entering or retrieving data by one or more computer system 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

Memory 620 may include program instructions 625, configured to implement embodiments of a layout-preserved text generation method as described herein, and data storage 635, comprising various data accessible by program instructions 625. In one embodiment, program instructions 625 may include software elements of a method illustrated in the above Figures. Data storage 635 may include data that may be used in embodiments described herein. In other embodiments, other or different software elements and/or data may be included.

Those skilled in the art will appreciate that computer system 600 is merely illustrative and is not intended to limit the scope of a layout-preserved text generation method as described herein. In particular, the computer system and devices may include any combination of hardware or software that can perform the indicated functions, including computers, network devices, internet appliances, PDAs, wireless phones, pagers, etc. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations. In some embodiments, portions of the techniques described herein (e.g., marketing campaign manager 170) may be hosted in a cloud computing infrastructure.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Various modifications and changes may be to the above technique made as would be obvious to a person skilled in the art having the benefit of this disclosure. It is intended that the invention embrace all such modifications and changes and, accordingly, the above description to be regarded in an illustrative rather than a restrictive sense. While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. Any headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

1. A method for managing, based on availabilities of products or service, content of online advertisements provided via data networks and associated with the products or services, the method comprising:
transmitting, to a web server, a first message via a data network from a computing device managing an online advertisement campaign, wherein the first message includes instructions for the web server to include, during a first time period and in a first list of search results generated by a search engine, an online advertisement having a webpage link for purchasing a product or service;
determining, by the computing device and subsequent to the first time period, that an availability of the product or service has been reduced and that an alternative product or service has a greater availability as compared to the product or service;
determining, by the computing device, a modification for the online advertisement based on the reduced availability of the product or service, wherein the modification comprises removing the webpage link from the online advertisement and replacing the webpage link with an alternative webpage link for purchasing the alternative product or service; and
transmitting a second message from the computing device to the web server, wherein the second message includes instructions for the web server to implement the modification by including, during a second time period and in a second list of search results generated by the search engine, the online advertisement with the alternative webpage link rather than with the webpage link.

2. The method of claim 1, further comprising:
accessing, by the computing device and from a non-transitory computer-readable medium, a rule for managing the online advertisement campaign; and
determining, based on the rule, that the alternative product or service is to be offered if the availability of the product or service is below a threshold, wherein the second message is transmitted based on the rule specifying the alternative product or service.

3. The method of claim 2, further comprising:
updating, with the computing device and prior to transmitting the first message, a mapping of product identifiers and keywords for online advertisements, wherein the first message is transmitted based on retrieving, from availability status data stored on the non-transitory computer-readable medium and using a product identifier from the mapping, an availability status for the product or service;
accessing, by the computing device and subsequent to transmitting the first message, the availability status data to determine an updated availability status for the product or service and an availability status for the alternative product or service; and
determining the modification based on accessing the updated availability status for the product or service and availability status for the alternative product or service.

4. The method of claim 3, wherein a plurality of rules comprising the rule are configurable via the data network by computing devices corresponding to providers of products or services.

5. The method of claim 1, wherein transmitting the first message comprises transmitting a keyword bid for a keyword associated with the online advertisement, wherein a search query received by the web server returns the first list of search results and wherein the online advertisement is included in the first list of search results based on the keyword bid.

6. The method of claim 1, further comprising:
identifying a keyword bid causing the online advertisement to be included in the first list of search results;
based on determining that the alternative product or service has the greater availability as compared to the product or service, maintaining the keyword bid during the second time period.

7. The method of claim 1, further comprising:
accessing, by the computing device and from a non-transitory computer-readable medium, a rule for managing the online advertisement campaign; and
determining, based on the rule, that the keyword bid is to be maintained.

8. A system comprising:
a network interface device communicatively coupling the system to a web server, the network interface device configured for transmitting, to the web server, a first message having instructions for the web server to include, during a first time period and in a first list of search results generated by a search engine, an online advertisement having a webpage link for purchasing a product or service;
a processing device communicatively coupled to the network interface device;
a non-transitory computer-readable medium communicatively coupled to the processing device, wherein the processing device is configured for executing instructions stored in the non-transitory computer-readable medium and thereby performing operations comprising:
determining, subsequent to the first time period, that an availability of the product or service has been reduced and that an alternative product or service has a greater availability as compared to the product or service,
determining a modification for the online advertisement based on the reduced availability of the product or service, wherein the modification comprises removing the webpage link from the online advertisement and replacing the webpage link with an alternative webpage link for purchasing the alternative product or service, and
generating a second message with instructions for the web server to implement the modification by including, during a second time period and in a second list of search results generated by the search engine, the online advertisement with the alternative webpage link rather than with the webpage link,
wherein the network interface device is further configured for transmitting the second message to the web server.

9. The system of claim 8, the operations further comprising:
accessing, from the non-transitory computer-readable medium or another non-transitory computer-readable medium, a rule for managing an online advertisement campaign; and
determining, based on the rule, that the alternative product or service is to be offered if the availability of the product or service is below a threshold, wherein the second message is transmitted based on the rule specifying the alternative product or service.

10. The system of claim 9, the operations further comprising:
updating, prior to the first message being transmitted, a mapping of product identifiers and keywords for online advertisements, wherein the first message is transmitted based on retrieving, from availability status data stored on the non-transitory computer-readable medium and using a product identifier from the mapping, an availability status for the product or service;
accessing, subsequent to the first message being transmitted, the availability status data to determine an updated availability status for the product or service and an availability status for the alternative product or service; and
determining the modification based on accessing the updated availability status for the product or service and availability status for the alternative product or service.

11. The system of claim 10, wherein the processing device is configured for providing access to a plurality of rules that comprise the rule and that are configurable via a data network by computing devices corresponding to providers of products or services.

12. The system of claim 8, wherein transmitting the first message comprises transmitting a keyword bid for a keyword associated with the online advertisement, wherein a search query received by the web server returns the first list of search results and wherein the online advertisement is included in the first list of search results based on the keyword bid.

13. The system of claim 8, the operations further comprising:
identifying a keyword bid causing the online advertisement to be included in the first list of search results;
based on determining that the alternative product or service has the greater availability as compared to the product or service, maintaining the keyword bid during the second time period.

14. A non-transitory computer-readable medium storing program instructions that are executable by a processing device, the program instructions comprising:
instructions for managing a frequency with which access to online advertisements is provided via a data network, wherein managing the frequency comprises:
causing a web server to include, during a first time period and in a first list of search results generated by a search engine, an online advertisement having a webpage link for purchasing a product or service;
determining, subsequent to the first time period, that an availability of the product or service has been reduced and that an alternative product or service has a greater availability as compared to the product or service;
determining a modification for the online advertisement based on the reduced availability of the product or service, wherein the modification comprises removing the webpage link from the online advertisement and replacing the webpage link with an alternative webpage link for purchasing the alternative product or service; and
causing the web server to implement the modification by including, during a second time period and in a second list of search results generated by the search engine, the online advertisement with the alternative webpage link rather than with the webpage link.

15. The non-transitory computer-readable medium of claim 14, the program instructions further comprising:
instructions for accessing, from the non-transitory computer-readable medium or another non-transitory computer-readable medium, a rule for managing an online advertisement campaign; and
instructions for determining, based on the rule, that the alternative product or service is to be offered if the availability of the product or service is below a threshold, wherein the modification is implemented based on the rule specifying the alternative product or service.

16. The non-transitory computer-readable medium of claim 15, the program instructions further comprising:
updating, prior to the first time period, a mapping of product identifiers and keywords for online advertisements, wherein causing the web server to include the online advertisement comprises determining, from availability status data stored on the non-transitory computer-readable medium and using a product identifier from the mapping, an availability status for the product or service;
accessing, subsequent to the first time period, the availability status data to determine an updated availability status for the product or service and an availability status for the alternative product or service; and
determining the modification based on accessing the updated availability status for the product or service and availability status for the alternative product or service.

17. The non-transitory computer-readable medium of claim 16, wherein a plurality of rules comprising the rule are configurable via the data network by computing devices corresponding to providers of products or services.

18. The non-transitory computer-readable medium of claim 14, wherein causing the web server to include the online advertisement comprises transmitting a keyword bid for a keyword associated with the online advertisement, wherein a search query received by the web server returns the first list of search results and wherein the online advertisement is included in the first list of search results based on the keyword bid.

19. The non-transitory computer-readable medium of claim 14, the program instructions further comprising:
identifying a keyword bid causing the online advertisement to be included in the first list of search results;
based on determining that the alternative product or service has the greater availability as compared to the product or service, maintaining the keyword bid during the second time period.

20. The non-transitory computer-readable medium of claim 19, the program instructions further comprising:
accessing, from the non-transitory computer-readable medium or another non-transitory computer-readable medium, a rule for managing an online advertisement campaign; and
determining, based on the rule, that the keyword bid is to be maintained.
